(19) United States
(12) Patent Application Publication
(10) Pub. No.: US 2026/0259074 A1
(43) Pub. Date: Sep. 3, 2026

(54) METERING DEVICE HAVING A PLUG VALVE

(71) Applicant: SCHEUGENPFLUG GMBH, Neustadt (DE)

(72) Inventor: Harald Müller, Ingolstadt (DE)

(73) Assignee: SCHEUGENPFLUG GMBH, Neustadt (DE)

(21) Appl. No.: 18/880,155

(22) PCT Filed: Jun. 26, 2023
(86) PCT No.: PCT/EP2023/067268

§ 371 Date: Dec. 30, 2024

(30) Foreign Application Priority Data
Jul. 6, 2022 (DE) 10 2022 116 856.5

(51) Int. Cl. G01F 15/00; G01F 11/02; G01F 15/12

(52) U.S. Cl. CPC G01F 15/005; G01F 11/029; G01F 15/12

(57) ABSTRACT

In order to be able to exactly meter out even very small amounts, at least the outlet valve of the metering device—usually a piston metering device—is designed as a plug valve, having an axially displaceable or rotatable valve body. The inlet valve can likewise be a plug valve or also a diaphragm valve. The design comprising a displaceable valve body is preferred.

### I. FIELD OF APPLICATION

The invention relates to a metering means, in particular a piston metering means, for pasty materials, comprising a valve, in particular an outlet valve.

### II. Technical Background

In the case of metering means that operate non-continuously, the inlet line and/or the outlet line must generally be closable by a valve.

In the case of piston metering means, the respective, usually pasty, material is drawn into a metering cylinder, which, when the metering piston is retracted, accommodates the desired metering quantity, from a storage container via a connected inlet line, by retracting the metering piston, or flows into the metering cylinder due to gravity and fills the metering cylinder. Subsequently, the metering quantity contained in the metering cylinder is metered out by pushing the metering piston forwards, in that it is supplied to the desired outlet opening, usually a nozzle or an upstream mixing tube, via an outlet line.

This often takes place for two metering cylinders at the same time, side-by-side, for e.g. binders and hardeners of a two-component adhesive.

For this purpose, usually an inlet valve is installed in each inlet line and an outlet valve is installed in each outlet line, which valves are generally I/O valves, in order to hold the outlet line closed when filling the metering cylinder and to hold the inlet line closed when metering out towards the outlet opening.

The inlet and outlet valves are frequently designed as diaphragm valves, in which the component to be metered is located just on one side of the diaphragm, which can be pressed against the sealing surface from the other side of the diaphragm, by means of a closing cylinder, in order to block the flow through the valve, for the material. Since the material flows only slightly along the surface of the diaphragm, the wear thereof is low, even in the case of abrasive material.

However, in the case of very small metering volumes compared with the volume of the working space of the opened diaphragm valve the metering is imprecise, since the diaphragm may stretch somewhat or change in rigidity, due to age, and thus the metering volume may change.

### III. PRESENTATION OF THE INVENTION

### a) TECHNICAL PROBLEM

The problem according to the invention is therefore that of providing a metering means, in particular a piston metering means, comprising a valve, in particular an outlet valve, which avoids this disadvantage.

### b) SOLUTION TO THE PROBLEM

This problem is solved by the features of claim 1. Advantageous embodiments emerge from the dependent claims.

In the case of a metering device of the type in question, comprising one or more metering means, in particular piston metering means, which each comprise an inlet valve and an outlet valve, at least one of these two valves is designed according to the invention as a plug valve.

For the purpose of the present invention, a plug valve is understood to be a valve in which an in particular frustoconical or cylindrical valve body is arranged tightly in main body and so as to be pivotable about its axial direction, or a valve body of any cross-section is displaceable back and forth, tightly in a main body, axially, transversely to the progression direction of the through-channel for the material that penetrates it, in each case so far that the outlets of the through-channel overlap at least in part with the adjoining projection channels (open position) or overlap completely with the adjoining projection channels (closed position).

Both the main body and the valve body have a through-opening that extends usually radially, i.e. in a transverse direction.

### Rotatable Valve Body

In that by means of such displacement or rotation of the valve body, known as the plug, the outlets of the radial through-opening of which and the outlets of the radial through-opening of the main body are brought into a partially or completely over-lapping position relative to one another, the valve is opened partially or entirely, and the material can flow radially through the main body from one side to the other.

At least one annular surface around the respective outlet of the main body serves as the seat surface, i.e. the contact surface for the sealing surface of the valve body, at least one annular surface around the respective outlet of the valve body, or also the respective entire inner peripheral surface of the main body in the axial region in which its outlets are located, or the entire outer peripheral surface of the valve body in the axial region in which its outlets are located, serves as the sealing surface.

If the valve body is rotated about its axial axis or displaced in the axial direction to such an extent, relative to the main body, that the alternating outlets of the radial through-openings of the valve body and main body no longer overlap, the valve is closed, since the outer periphery of the valve body rests tightly on the inner periphery of the main body.

In the case of a cylindrical valve body and correspondingly cylindrical seat surface in the main body, this is achieved by correspondingly precise manufacturing tolerances above all of the diameters, in the case of the frustoconical design of the valve body and analogous seat surface in the main body this can be achieved by an axial preloading of the valve body in the direction of the tapering cross-section of the valve seat in the main body.

The advantage of a plug valve essentially consists in that by displacing or rotating the valve body from the opened into the closed position, on the outlet side of the main body, no additional material is pushed into the outlet line that adjoins the valve main body on the output side, such that very exact metering out even of—in particular in comparison with the volume of the radial through-opening of the valve body—very small metering quantities is possible, in contrast to other valve forms, such as a diaphragm valve.

The disadvantage of a plug valve is that the material can arrive at the seat surface of the valve between the valve body and the main body, and thus causes relatively rapid wear on both due to their relative movement.

In order to reduce the wear, a material pairing between the seat surface on the main body and the sealing surface of the valve body is selected, the materials of which have significantly different hardnesses, in particular the valve body consists at least on its outer periphery of the softer material, preferably a plastics material such as HPU, PTFG or polyethylene, while the seat surface of the main body consists of a harder material, whether a harder plastics material or preferably metal, in particular hardened metal.

At this point, it should be made clear that the seat surface and the sealing surface do not have to be surfaces in the geometric sense, which do not have any extension transversely to the surface, but rather surfaces of which the thickness can be different from zero.

In particular, the outer peripheral surface of the valve body consists at least at its sealing surfaces of a softer material having a Shore hardness of at most 96, in particular at most 70, in particular at most 55, and/or a tensile strength of at most 60 MPa, in particular at most 50 MPa, and/or an ultimate elongation of at least 350%, in particular at least 400%.

As a result of this measure, on the one hand abrasive, hard particles of the mass to be conveyed can be pressed into the softer material of this material pairing, and thus not yet create any wear on said softer material, and on the other hand the occurring wear occurs primarily on the softer material of this material pairing, preferably the valve body, which, however, can be changed more easily than the main body of the plug valve that is fixedly installed in the surrounding structure.

One possibility consists in the—above all in a frustoconical design—outermost layer of the peripheral surface of the valve body being formed as a replaceable sleeve of soft material, and after removal of the valve body from the main body can be easily changed on the valve body.

Another possibility consists in the valve body consisting preferably over its entire cross-section of the softer material of its outer peripheral surface, i.e. is a valve body that is solid with respect to the soft material, which is merely penetrated by the transverse hole.

However, in the case of a frustoconical design wear can—if the largest cross-section of the transverse hole in the valve body is relatively large compared with the taper angle of the truncated cone, i.e. for example the taper angle to the axial direction is at least 10°, preferably at least 20°, preferably at least 30°—still be compensated for a long time with sufficiently great overlap of the outlets in the opened valve position by readjusting the valve body in the axial direction.

This advantage does not exist in the case of a cylindrical valve body. Here, a wear-related diameter difference between the sealing surface of the valve body and the seat surface in the main body can only be reduced in that the softer material of the material pairing, in particular the sealing surface on the side of the valve body, is selected to be so soft and resilient that an increase in diameter of the peripheral surface of the valve body in the axial region of the outlets can be achieved by axial compression, which is possible above all if the valve body consists, in the region of the through-opening, integrally over the entire cross-section of said softer, resilient material.

In addition, a quick and easy exchange of the valve body should be ensured, in that the valve body can be easily dismantled and mounted, preferably in less than 1 min and without special tools, at best entirely without tools.

In the case of a rotatable, i.e. pivotable, valve body, this is operatively connected, in particular at one of its end regions, to a swivel drive, which causes the pivoting from the open position into the closed position.

The swivel drive is preferably a pneumatic cylinder, which acts off-center and in the tangential direction on the valve body or a flange protruding radially therefrom, and the piston of which can be retracted and extended between two end positions, or any other swivel drive, such as a cog drive or a drive by means of a threaded spindle, which in particular has a very significant pitch.

In general, for reasons of better mounting, in particular rotatable mounting, the valve body is part of a plug shaft which is mounted in the main body on both sides of the valve seat.

In the case of a frustoconical valve body, the plug shaft can be mounted by rolling bearings on the side of the smaller cross-section of the valve body, preferably both radially and axially, in particular in a combined radial/axial bearing, and on the side of the larger cross-section of the valve body only by a radial bearing, which allows for axial delivery, and therefore often no rolling bearing, but rather only a plain bearing, it being possible in particular for a seal, present there in any case, to serve as the plain bearing.

In the case of the design having a cross-section that remains the same in the region of the sealing surface, in particular a cylindrical design, of the valve body, a bearing, in particular rolling bearing, can be provided at least at one end region, both in the radial and in the axial direction, and in contrast at the other end at most in the radial direction, which allows a relative movement in the axial direction between the two end regions of the plug shaft for compressing the resilient valve body or at least its peripheral surface in the axial direction.

The valve body consisting of the softer material is preferably detachably connected at its end faces with respect to the two adjacent end parts of the plug shaft, and in this way can be easily exchanged—in the case of a plug shaft removed from the main body—by releasing the connection to the two adjacent end parts parts of the plug shaft and inserting a new valve body therebetween.

For this purpose, the connection takes place for example by axially screwing remotely from the through-opening, through the valve body, or by radially inserting the valve body between the two end parts of the plug shaft, preferably along form-fitting, in particular undercut, alternating guides, which securely hold the valve body both in the axial direction and in the rotational direction, on the remainder of the plug shaft.

In addition, in the case of this design having a uniform cross-section of the valve body, at least in the region of its sealing surface, in the case of a rotatable plug shaft an axial stop is required for the plug shaft, in order to be able to apply an axial force to the plug shaft, and thus to the valve body, from the opposite side of the sealing body.

In the case of a plug shaft that is axially displaceable for opening and closing, a stop of this kind is not sensible, but rather preferably the two end regions of the plug shaft are then preloaded against one another, in order to bring about permanent compression and thus transverse extension of the valve body.

This can take place by means of one or more axially extending tensioning screws, which pass by the through-opening through the valve body, which through-opening does not necessarily have to be arranged centrally. In the case of a single central tensioning screw, this can be configured as a threaded bolt on one end part and as a threaded hole in the opposing other end part, when the passage requirement extends transversely thereto, past the donor tensioning screw.

In addition, in this case a tensioning element such as a spring is preferably also installed, which maintains the axial preload on the valve body over a wide wear range, for example in the form of a disc spring.

It should be clarified that despite the term plug shaft in the design in which the valve body is axially displaced between an open position and a closed position, the cross-section of said plug shaft does not have to be rotationally symmetrical, but rather can for example also be polygonal, in particular rectangular.

In order that in the case of a pivotable plug shaft the swivel position of the plug shaft and thus of the valve body is known at all times, swivel position monitoring for the valve body is provided.

Preferably, for this purpose the plug shaft—in the axial direction beyond the valve body—comprises a radially protruding projection, in particular a flange, the swivel position of which is monitored, preferably in a contactless manner, by an angle sensor, at least with respect to the two end positions, and is notified to the controller of the metering device.

This can be the same radially protruding projection or flange on which the swivel drive also acts, preferably off-center in a tangential direction.

In order to prevent forward penetration of the material, in particular when this is abrasive material, between the seat surface and sealing surface, and in particular out of the valve towards its mounting on both sides, rinsing pockets are arranged around the plug shaft, in the valve seat, i.e. in the main body.

For this purpose, rinsing pockets can be arranged around the plug shaft spaced apart from the actual plug valve, i.e. the seat surface, in the axial direction.

Preferably, however, the rinsing pockets are arranged in the axial region of the seat surface and the sealing surface, but offset from the outlets in the peripheral direction, in particular the seat surfaces surrounding the outlets.

The rinsing pockets are fluidically connected to a rinsing circuit and a rinsing fluid flows through them, which transports away material entering the rinsing pockets.

### c) EMBODIMENTS

Embodiments according to the invention are explained in greater detail, by way of example, in the following. In the drawings:

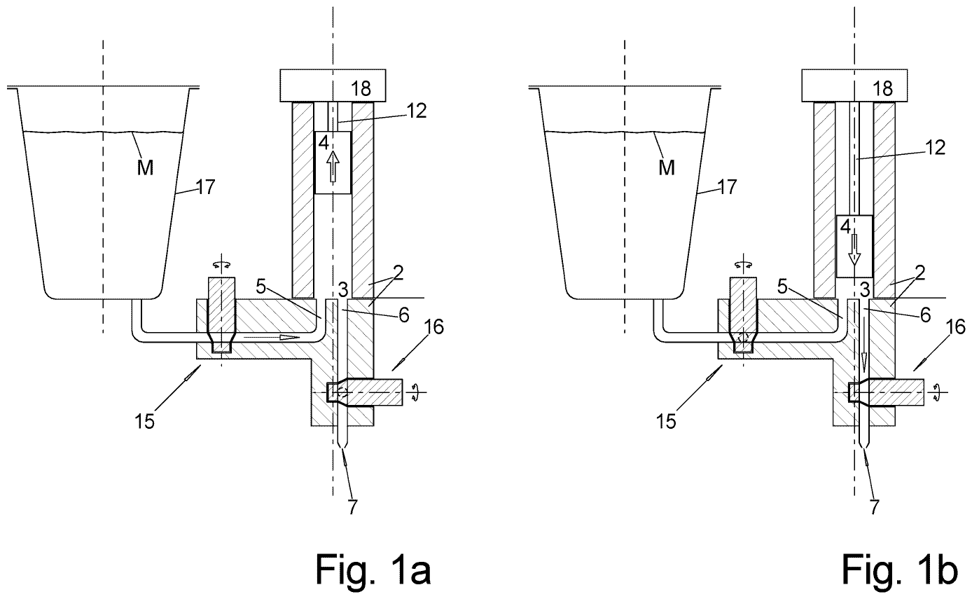

FIG. 1a, b: are cross-sections through a piston metering means, the inlet and outlet valve of which are designed as plug valves, in different functional positions,

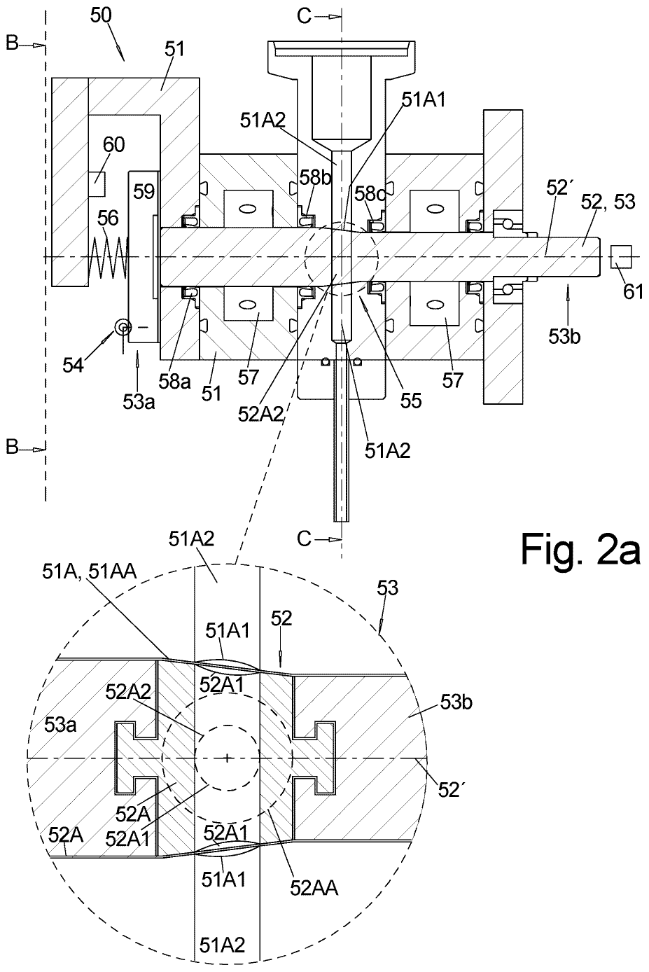

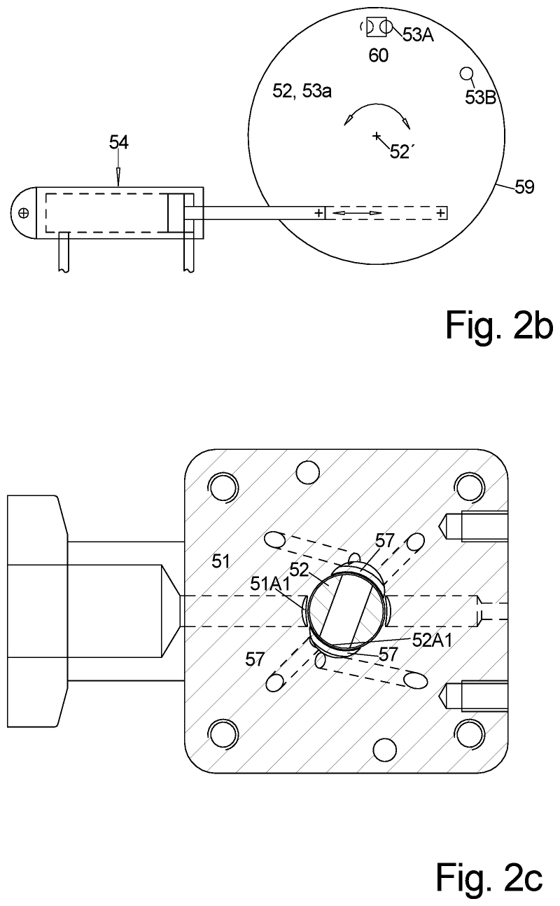

FIG. 2a-c: show a first design of the plug valve comprising a rotatable, frustoconical valve body, cut in the axial direction of the valve body,

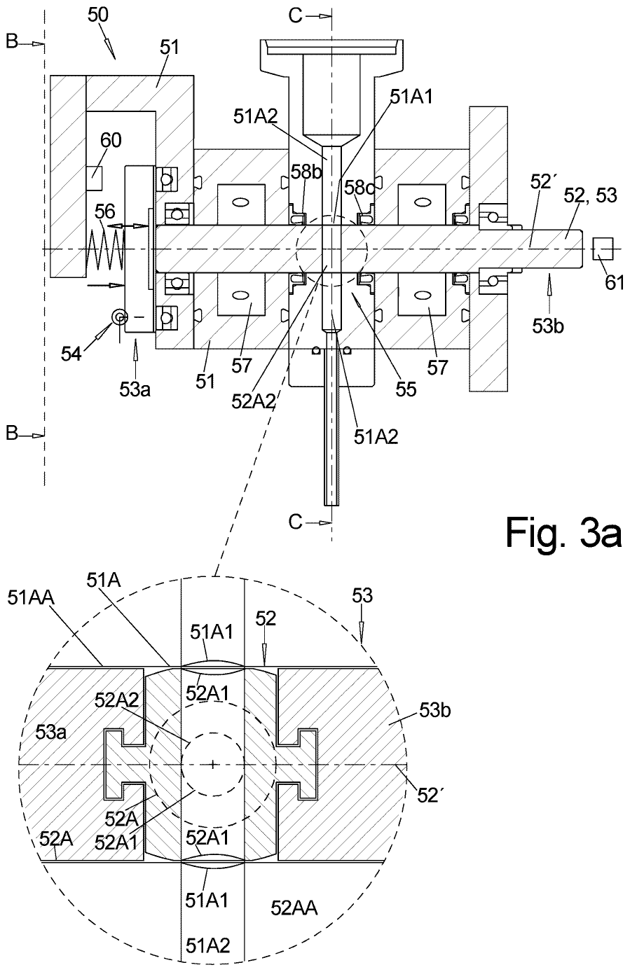

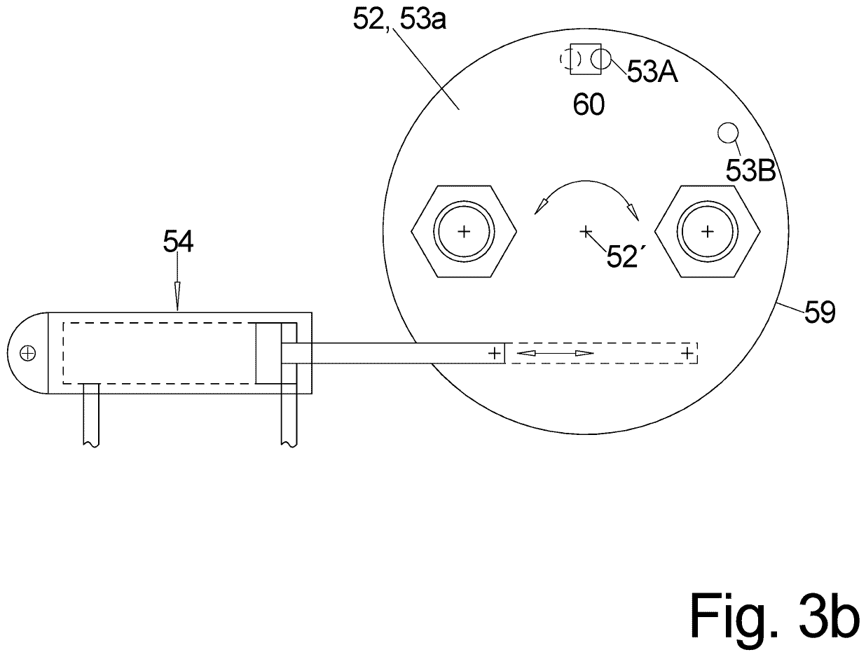

FIG. 3a, b: show a second design of the plug valve comprising a rotatable, cylindrical valve body in analogous views according to FIG. 2a, b,

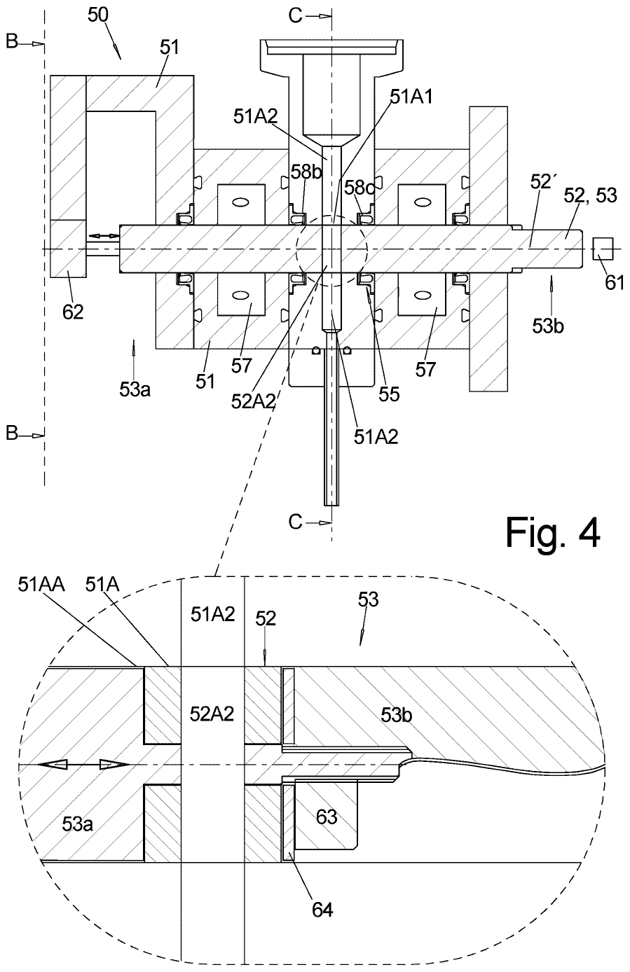

FIG. 4: shows a third design of the plug valve comprising a displaceable valve body in an analogous view according to FIG. 3a, also with a detail enlargement.

FIG. 1a, b show a piston metering means 1 in which a valve device 50 according to the invention having a plug valve 55 both as the outlet valve 16 and as the inlet valve 15 is used, in the different movement phases.

Frequently, in a metering device two or even more piston metering means 1 are provided side-by-side for metering a plurality of material components that are to be mixed together, such as binders and hardeners of an adhesive, which can be driven together e.g. from a common drive with synchronous movements of their piston rods.

As FIG. 1a, b show, an inlet line 5, via which the material M to be metered is supplied from a storage container 17 to the metering cylinder 3 formed in the main body 2, and an outlet line 6, via which the defined metering quantity of material M, contained in the metering cylinder 3 after this has been filled, is discharged from the metering piston 4 in the direction of the outlet opening 7, lead into the metering cylinder 3, specifically into its lower end face.

FIG. 1a Shows the Filling of the Metering Volume Into the Metering Cylinder 3:

In this case, the outlet valve 16 is closed and the inlet valve 15 is opened, such that when the metering piston 4—which is moved by means of a motor 18—is moved back in the direction of the enlarging volume of the working space in the metering cylinder 3, the medium to be metered is suctioned or flows out of the storage container into the metering cylinder 3, until the metering piston is in the completely retracted position which corresponds to the desired metering volume in the metering cylinder 3.

In this position of the metering piston 4, the inlet valve 15 is closed and according to FIG. 1b the metering piston 4 is moved forwards with the aid of the motor 18. The material M contained in the metering cylinder 3 can thus leave the metering cylinder 3 only via the outlet line 6, which must of course be opened for this purpose.

In that the metering piston 4 is shifted forward approximately to the base of the metering cylinder 3, the metering volume corresponding to the stroke volume of the metering piston 4 is pressed out via the outlet line 6, since the outlet line 6 is continuously filled up to the outlet opening 7.

FIG. 2a, b show a first design of a plug valve 55 comprising a frustoconical, conical valve body 52 that is rotatable about the axial direction, the plug, in the opened position in axial section in FIG. 2a and in the end-face plan view in FIG. 2b, and in FIG. 2c in the closed position in a section transversely to the axial direction 52′.

As is more clearly visible in the detailed view of FIG. 2a, in the opened position the through-channel 52A2, which extends transversely to the axial direction and is usually designed as a transverse hole and which extends radially through the valve body 52, aligns with the supply channels 51A2 adjoining it on both sides, in the surrounding seat body 51, in that in each case an outlet 52A1 in the valve body 52 overlaps as completely as possible with the opposing outlet 51A1 in the seat body 51.

If the valve body 52, which can be part of a plug shaft 53, in that it is fastened in an axially adjoining manner between the two end regions 53a, 53b thereof, is pivoted by means of the swivel drive 54, in this case a pneumatic cylinder, to such an extent that there is no longer any overlap, the plug valve 55 is in the closed position, as can be seen in the cross-sectional view of FIG. 2c.

As FIG. 2b shows, the pneumatic cylinder 54 engages in a hinged manner on a fastening point of the valve body 52 located eccentrically to the swivel axis 52′, or a flange 59 protruding radially therefrom, or the entire encoder shaft 53, in particular the drive-side end 53a thereof, and, in the case of a pneumatic cylinder 54 that can be acted on from both sides, can pivot the valve body 52 back and forth between the open and the closed swivel position.

As the enlargement in FIG. 2a shows, the valve body 52, which is designed to be rotationally symmetrical about its swivel axis 52′, its longitudinal extension, has a frustoconical outer peripheral contour at least in the axial region of the outlets 52A1 of its transverse hole 52A2—which outlets are preferably located at the same axial position, just in different rotational positions, in particular opposite one another with respect to the swivel axis 52′, the axial direction—and the seat body 51 has an analogously shaped inner peripheral contour.

Said inner peripheral contour 51AA consists, at least around the outlets 51A1, as a seat surface, of a hard material, preferably along the entire inner peripheral contour, having an axial extension which is greater than the axial extension of the outlets 51A2, in particular over the entire extension of the frustoconical region.

As can be seen in the enlargement in FIG. 2a, in the case of occurring wear, i.e. abrasion, of the outer peripheral surface of the frustoconical valve body 52 said valve body can nonetheless be held in tight contact on the inner peripheral surface of the seat body 51 by further axial displacement to the right, even if the outlets 51A1 and 52A1, which are opposite one another in the open position, no longer overlap one another completely, but only in part, in the axial direction 52′, in the open position.

For this reason, the plug shaft 53 is preloaded axially in the direction of the narrow end of the frustoconical region by means of a preload element 56, for example a spring.

In this case, the wear state can be detected by an abrasion sensor 61, for example a distance sensor 61, which is fixedly mounted and directed against the end face on the, here right-hand, end 53b of the plug shaft 53, and can be notified to the controller (not shown) of the valve device 50 or the superordinate unit, for example the piston metering means 1.

Thereupon, the plug shaft 53 can be pulled out axially towards the left and the worn valve body 52 can be replaced.

As shown, in this case the valve body 52, which for example represents the frusto-conical region of the entire plug shaft 53 and consists, over its entire cross-section, of a softer material compared with the seat body 51—which usually consists of metal which is additionally hardened at the seat surface 51A—can be pushed in in a form-fitting manner by means of T-shaped grooves which extend in the transverse direction with respect to the longitudinal direction 52′ and which are formed for example in the end faces, facing it, of the regions 53a, b of the plug shaft 53, and can thus no longer detach from these regions 53a, b in the mounted state of the plug shaft 53.

The plug shaft 53 is supported by a radial rolling bearing on the end region 53b adjacent to the smaller diameter of the frustoconical portion, and in contrast, in the opposite end region 53a, here the end region adjacent to the swivel drive 54, mounted only in a resilient peripheral seal 58a, which is arranged in the seat body 51, in order to always ensure tight contact between the valve body 52 and the seat surface 5 A of the seat body 51.

In addition, the plug shaft is sealed on both sides with respect to the seat body 51, by further seals 58b, c that surround said plug shaft peripherally, closer to the frustoconical region.

Seals 58b, c that are axially further away from the supply channel 51A2, in each case a preferably annularly surrounding rinsing pocket 57 is formed in the inner periphery of the seat body 51, around the plug shaft 53, which pockets are connected via outlets, visible therein, to a rinsing circuit, and through which a rinsing fluid flows continuously or at time intervals, in order to conduct away material which has arrived therein from the supply channels 51A2 despite the seals.

In the inner periphery of the main body 51, furthermore rinsing pockets 57 are also provided in the axial region of the outlets 51A1, i.e. in the frustoconical region, which pockets are shown in FIG. 2c but extend in each case only over a part of the periphery, specifically in the region in which the outlets 52A1 of the transverse hole 52A2 are located in their rotational position of the valve body 52 that corresponds to the closed valve position.

These valve pockets 57 are also connected to the rinsing circuit via the supply channels shown, and are rinsed regularly, such that for this reason alone no material, and no abrasive particles contained therein, can permanently collect over a large part of the outer periphery of the valve body 52.

The end positions are monitored with respect to the swivel position of the valve body 52, in that one end, here the drive-side end, 53a of the plug shaft 53 is monitored by means of an angle sensor 60 with respect to its rotational position about the swivel axis 52′.

This can, as shown, take place by means of an, in particular contactlessly acting, angle sensor 60 directed to the end face of the plug shaft 53 or in this case a projection 59 that protrudes radially with respect to the plug shaft 53, which sensor can detect, with the aid of markings on said end face, which correspond to the two end positions and are spaced apart along the periphery, whether and in which end position the plug shaft 53 is located.

FIG. 3a, b show, in the same viewing direction as FIG. 2a, b, a second design of the plug valve 55, in which the valve body 52, likewise rotatable about the axial direction, has a cylindrical outer periphery and—preferably over its entire cross-section—consists of a material which is so resilient that it expands in the radial direction when pushed together in the axial direction.

In this way, in the case of wear on the cylindrical outer peripheral surface of the valve body 52 fastened between the end regions 5a, b of the plug shaft 53, which can consist of a hard material such as metal, can be compressed more strongly, axially, as shown here by two tensioning screws 62a, b, extending axially and remote from the transverse hole 52A2, which screws pull the two end regions 53a, b more strongly against one another.

As can be seen in the enlargement of FIG. 3a, the valve body 52 thereby expands radially and, despite wear, still rests closely and tightly on the seat surface 51A, the inner periphery of the seat body 51.

In the case of such a cylindrical valve body 52, which is always located, axially, at the same position relative to the seat body 51, the plug shaft 53 can be mounted by rolling bearings at the two end regions, as is conventional by means of a radial bearing in each case, and on one side by means of an additional axial bearing. With increasing bracing of the valve body 52, according to FIG. 3a the end region 53b of the plug shaft 53 remote from the axial bearing, which is located here on the left-hand side, will move increasingly closer to the other end region 53a.

FIG. 4 shows, in the same viewing direction as FIGS. 2a and 3a, a third design of the plug valve 55, in which a valve body 52 is displaceable axially back and forth transversely to the extension direction of its through-channel 52A2, i.e. in the longitudinal direction, for opening and closing, here by means of a slide drive 62 which acts on the left-hand end face of the plug shaft 53—which can have a rectangular or also round cross-section.

The plug shaft 53 is therefore preferably not in contact with an axial stop in any of the functional positions, but a sensor 61 probably detects which of the two axial end positions—open positions or closed position—the plug shaft 53 is currently in. Here, too, the valve body 52 consisting of resilient material can be held under pre-load in the axial direction, in order to compensate wear in the radial direction by the radial expansion brought about by said preload. The preload can be generated in different ways:

As shown in the enlargement in the bottom half, the end part 53a that is connected to the slide drive 62 has an axially protruding projection on the end face that faces the valve body 52, which projection is designed as a threaded bolt and which extends past the through-channel 52A2 extending in the transverse direction thereto.

In this case, it is irrelevant whether the threaded bolt is positioned centrally with respect to the end part 53a and the through-channel 52A2 is eccentric, or whether the through-channel 52A2 is arranged centrally and one such threaded bolt extends beside it in each case, for example on either side of it.

An axially resilient element, for example a disc spring 64, and optionally also a sleeve-shaped end part 53b, is threaded onto the threaded bolt—after threading on the valve body 52, which for this purpose comprises a corresponding through-opening extending in the axial direction—and thereafter a tensioning nut 63 is screwed on and tightened.

With increasing wear, the axially resilient element, for example the disc spring 64, expands from the flat disc-shaped state shown and in the process exerts an approximately uniform axial force on the valve body 52, which thereby rests radially tightly against the inner periphery 51AA of the seat body 51.

In the axial region of the sleeve-shaped end part 53b, a seal or bearing can then be located opposite the seat part 51 in the mounted state, if desired.

It is shown, in the top half, that a threaded hole is located in the end face of the other end part 53b facing the valve body 52, such that—again after threading on the valve body 52 and resilient element—the end part 53b can be screwed onto the threaded bolt in order to thereby apply an axial preload to the resilient element and thus the valve body 52.

For this purpose, the threaded bolt and also the threaded hole should of course extend centrally, in order that, irrespective of the rotational position, the two parts align with one another when tightened, and thus the through-channel 52A2 must extend eccentrically, in order that the two do not touch.

The advantage is that said end part 53b can be of any length, axially, and therefore, as in the overall view of FIG. 4, can be mounted relatively far away in the seat body 51, the mounting having to allow an axial displacement of the plug shaft 53, also including the rinsing pockets between the seat surface 51A and the bearing points.

Here, too, peripheral seals can simultaneously be used as plain bearings.

### LIST OF REFERENCE SIGNS

1 Piston metering means
2 Main body, seat body
3 Metering cylinder
4 Metering piston
5 Inlet line
6 Outlet line
7 Outlet opening
12 Piston rod
14 Inlet valve
15 Outlet valve
17 Storage container
18 Motor
50 Valve device
51 Seat body
51A Seat surface
51AA Inner peripheral surface
51A1 Outlet
51A2 Supply channel, projection channel
51.1 Seat body
52 Plug, valve body
52a, b End region
52′ Swivel axis, axial direction
52A Sealing surface
52AA Outer peripheral surface
52A1 Outlet
52A2 Through-channel, transverse hole
53 Plug shaft
53A, B Marking
53a, b Side, end
54 Swivel drive, pneumatic cylinder
55 Plug valve
56 Preload element
57 Rinsing pocket
58a-c Seal
59 Flange
60 Angle sensor
61 Wear sensor
62a, b Tensioning screw
63 Tensioning nut
64 Disc spring
M Material

1. Metering device, for metering viscous materials and optionally simultaneously mixing a plurality of components in the form of viscous materials, having one metering means per component, the metering device comprising:
an inlet line from the storage container and an outlet line opening in the metering cavity;
a valve device comprising an inlet valve in each inlet line; and
a valve device comprising an outlet valve in each outlet line wherein:
at least one of the valves is designed as a plug valve having a valve body as a closure element in a seat body;
a through-channel for the material through the valve body extends through the valve body in a transverse direction to the axial direction thereof; and
the valve body being rotatable about the axial direction or displaceable in the axial direction transversely to said transverse direction.

2. Metering device according to claim 1, wherein:
the metering means is a piston metering means comprising a metering cylinder in which a metering piston is displaceable in a manner driven via a piston rod or a plunger, by a motor.

3. Metering device according to claim 1, wherein:
the seat surface of the valve seat consists of a harder material, in particular of hardened metal, than the adjacent sealing surface of the valve body,
in particular the sealing surface adjacent to the seat surface of the valve seat, in particular the entire inner peripheral surface of the valve body, consists of a plastics material, in particular of HPU, PTFE or polyethylene.

4. Metering device according to claim 1, wherein:
the material at least of the sealing surface, in particular of the entire outer peripheral surface, of the valve body has a Shore hardness of at most 96, and/or a tensile strength of at most 60 MPa, and/or an ultimate elongation of at least 350%.

5. Metering device according to claim 1, wherein:
in the case of a rotatable valve body
the plug valve comprises a frustoconical valve body,
in particular the taper angle (a) of the truncated cone with respect to the axial direction is at least 10°.

6. Metering device according to claim 1, wherein:
the valve body is preloaded into the valve seat, in particular the inner peripheral surface in the axial direction.

7. Metering device according to claim 1, wherein:
in the case of a rotatable valve body the plug valve has a cylindrical outer peripheral surface and the main body has a cylindrical inner peripheral surface,
in the case of an axially displaceable valve body the plug valve has any desired cross-sectional shape, and the seat body has an analogous cross-sectional shape.

8. Metering device according to claim 1, wherein:
on the side of the valve body, the material at least of the sealing surface is so soft and resilient that an increase in diameter of the outer peripheral surface of the valve body in the axial region of its outlets can be achieved by axial compression of the valve body.

9. Metering device according to claim 1, wherein:
the valve body is an axial portion of a plug valve that is rotatable about the axial direction,
which in particular protrudes from the seat body of the plug valve on both sides.

10. Metering device according to claim 1, wherein:
the valve body including its peripheral surface consists of the same material, in particular plastics material, and is non-rotatably and/or axially fixedly connected to the two end parts of the plug valve in particular releasably connected,
in particular force can be applied axially to the valve body between the two ends
either by axially preloading the two ends against one another or by one end resting axially on a stop, in particular an axial bearing, and axial force being applied to the other end.

11. Metering device according to claim 1, wherein:
the plug shaft is operatively connected to a swivel drive or a slide drive,
is radially mounted, on the preload side only in a peripherally surrounding resilient seal,
and/or
is mounted in rolling bearings at least in the radial direction, in particular also in the axial direction, on the side facing away from the axial preload.

12. Metering device according to claim 1, wherein:
rotation angle monitoring and/or axial position monitoring of the valve body, in particular of the entire plug shaft is provided,
in particular in the form of a flange that protrudes radially beyond the plug shaft and an angle sensor which monitors the rotational position about the axial direction in particular in a contactless manner, and which can monitor in particular the end positions of the plug shaft in particular of the flange.

13. Metering device according to claim 1, wherein:
at least one rinsing pocket, connected to a rinsing circuit, is provided at the parked position of the outlet, spaced apart from the seat surface in the peripheral direction, in the inner peripheral surface of the seat body facing the valve body.

14. Metering device according to claim 1, wherein:
at least one rinsing pocket, connected to a rinsing circuit, is provided, spaced apart from the seat surface in the axial direction, in the inner peripheral surface of the main body facing the valve body.
